(19) United States
(12) Patent Application Publication
(10) Pub. No.: US 2008/0153717 A1
(43) Pub. Date: Jun. 26, 2008

(54) METHODS OF FORMING AND USING AN IN SITU HEAVY HYDROCARBON EMULSION

(76) Inventors: Daniel Guy Pomerleau, Calgary (CA); Ronald Vertz, Calgary (CA)

Correspondence Address: THELEN REID BROWN RAYSMAN & STEINER LLP, P.O. BOX 640640, SAN JOSE, CA, 95164-0640, US

(21) Appl. No.: 11/855,136

(22) Filed: Sep. 13, 2007

Related U.S. Application Data
(60) Provisional application No. 60/825,691, filed on Sep. 14, 2006.

(51) Int. Cl. C09K 8/68

(52) U.S. Cl. 507/232

(57) ABSTRACT

The present invention relates to methods of forming and using an in situ heavy hydrocarbon emulsion produced during drilling operations from heavy oil and/or crude bitumen recovered through processes such as cyclic steam stimulation and steam assisted gravity drainage (SAGD). After optional upgrading at the surface, the emulsion may be used as a road construction material, fuel source or an asphalt emulsion flux.

### CROSS REFERENCE TO RELATED APPLICATIONS

This application claims priority to and incorporates by reference U.S. Patent Application No. 60/825,691 filed Sep. 14, 2006.

### FIELD OF THE INVENTION

The present invention relates to methods of forming and using an in situ heavy hydrocarbon emulsion produced during drilling operations from heavy oil and/or crude bitumen recovered through processes such as cyclic steam stimulation and steam assisted gravity drainage (SAGD). After optional upgrading at the surface, the emulsion may be used as a road construction material, fuel source or an asphalt emulsion flux.

### BACKGROUND OF THE INVENTION

As is known, heavy oil and bitumen (collectively referred to herein as “heavy hydrocarbons”) have a high viscosity at formation temperature. As a result, during production of such heavy hydrocarbons, some form of heat or dilution of the hydrocarbons is required to enable the heavy hydrocarbons to flow from the formation to a production well as the heavy hydrocarbons will not flow under the virgin temperature and pressure conditions of the formation.

Steam assisted gravity drainage (SAGD) is a well known enhanced recovery technique to recover heavy hydrocarbons from an oil field. Generally, SAGD techniques are used to recovery heavy hydrocarbons from a formation that would not otherwise be released from the formation without the use of steam to heat the formation. The introduction of steam heat to the formation will reduce the viscosity of the heavy hydrocarbons and allow the heavy hydrocarbons to flow to a recovery well.

SAGD operations are usually relatively large scale operations, often requiring injection and recovery wells of considerable length to effectively enable the recovery of hydrocarbons over a substantial horizontal distance. As a result, injection and recovery wells are drilled over these horizontal distances through the heavy hydrocarbon zones of a formation.

In the drilling of SAGD injection and recovery wells, the disposal of drill cuttings has been a significant issue for drill site operators. For example, in a typical drilled SAGD operation, upwards of 100 m³ of drill cuttings may be produced from a single injection or recovery well. Typical drill cuttings contain a variety of contaminants including the heavy hydrocarbons, salts, metals, soaps and other agents that may have been added to the drilling fluid to assist in the drilling processes.

As a result of the contaminants, disposal of these materials is expensive. Acceptable methods of disposal of drill cuttings are usually dictated by various jurisdictional regulations and will usually require that the drill cuttings are properly remediated into the local soil or alternatively, removed to a landfill site. Either disposal method may lead to certain environmental contamination as the various contaminants may ultimately leach into the local groundwater. Moreover, the cost of transportation of drill cuttings to a landfill and/or the cost of soil remediation is significant.

For example, in a typical heavy oil or bitumen drilling process, recovered and dried drill cuttings may include approximately 15% (w/w) heavy hydrocarbon contaminants. Such levels of heavy hydrocarbons represent a significant volume of hydrocarbons and pose a significant disposal problem.

As is known, road construction is subjected to specific environmental regulations that may or may not be similar to either a local drilling site or landfill. That is, at a local drill site, as a result of the relative concentration of contaminants within drill cuttings, regulations are usually relatively strict concerning acceptable levels of contaminants that may be contained within a particular area without proper remediation or disposal. In contrast, during the construction of a road, the same standards would generally not apply. That is, it is well known that government agencies and their contractors use hydrocarbons and/or chlorides mixed with gravel aggregates to provide dust suppression in gravel or dirt roads. At a drill site, acceptable levels of hydrocarbons present within the soil would be relatively low whereas in providing dust suppression to a gravel or dirt road significantly higher levels of hydrocarbons in the form of crude oil can be laid down over large areas notwithstanding that it is known that certain quantities of the hydrocarbons will, over time dissipate from the road into the local environment.

As a result, there has been a need for effective disposal methods wherein bitumen or heavy hydrocarbon contaminated drill cuttings are disposed of in a manner that meets environmental regulations and that does not significantly increase or otherwise adversely affect the overall cost of disposing of such drilling cuttings. More specifically, there has been a need for a disposal method in which the bitumen contaminated drill cuttings provide a useful product and where in one method the bitumen is emulsified during drilling to produce a useful bitumen emulsion for use in roads or alternatively as a fuel source.

### SUMMARY OF THE INVENTION

In accordance with the invention, there is provided a method of preparing a viscous heavy hydrocarbon/drilling solution emulsion comprising the step of preparing a water-based drilling solution containing an effective amount of a surfactant wherein the drilling solution is effective in emulsifying heavy hydrocarbon from a production zone and forming a viscous heavy hydrocarbon/drilling solution emulsion with suspended drill cuttings during drilling. The concentration of heavy hydrocarbon within the viscous heavy hydrocarbon/drilling solution emulsion and drill cuttings mixture is preferably 60% (w/w) or higher.

The mixture may be used for different downstream uses including road construction or a fuel. In either use, the hydrocarbon fraction within the heavy hydrocarbon/drilling solution emulsion with suspended drill cuttings may be increased or adjusted as appropriate to create an asphalt emulsion suitable for road construction or to create a fuel. Suspended drill cuttings may be separated from the emulsion.

In another embodiment, the invention provides a water-based drilling fluid produced from downhole drilling comprising: a water phase; at least one surfactant for dispersing/emulsifying downhole heavy hydrocarbons; emulsified heavy hydrocarbon and, drill cuttings from the downhole drilling, wherein the water-based drilling fluid is characterized by having at least 60% (w/w) dispersed heavy hydrocarbon with respect to the water phase and associated drill cuttings.

In yet another embodiment, the invention provides a method of preparing a drilling fluid comprising the steps of: forming a water-based drilling fluid with an emulsifier; drilling a wellbore with the water-based drilling fluid wherein upon approaching a planned drilling distance through a production zone having heavy hydrocarbons, the viscosity of the drilling fluid is permitted to increase by increasing the concentration of emulsified heavy hydrocarbon within the drilling fluid; and, recovering the viscous drilling fluid at the surface.

### DETAILED DESCRIPTION

Methods of preparing and using a drilling solution emulsion that contains a high concentration of emulsified heavy hydrocarbons are described. The drilling fluid emulsion with or without suspended drill cuttings may be thereafter used as a road construction material or as fuel.

More specifically, and in accordance with the invention, a water-based drilling fluid containing suitable surfactants for dispersing/emulsifying downhole heavy hydrocarbons (preferably bitumen) are prepared such that the resulting heavy hydrocarbon/drilling fluid/drill cuttings mixture produced during drilling is an effective and viscous blend of emulsified hydrocarbons (preferably asphaltenes) and suspended drill cuttings that are suitable for road construction or as a fuel.

The method of the invention initially involves the creation of a water-based drilling fluid containing at least one heavy hydrocarbon (including asphalt/bitumen) emulsifier. Thereafter, using this drilling fluid, the drill operator will commence drilling towards the production zone of a formation in the known manner. That is, normal drilling practices would be observed including increasing the downhole drilling fluid volume and adjusting the drilling fluid composition as drilling progresses.

Upon reaching the production zone, and particularly in the case of SAGD production, the drill operator may change the drilling direction to horizontally penetrate the production zone with the objective of thereafter advancing the horizontal section through the production zone to a planned distance.

As the production zone is drilled, and in accordance with the invention, the drilling operator will maintain the properties of the drilling fluid such that effective drilling can occur through the production zone. In the case of a bitumen production zone, the drill bit will be penetrating through bitumen and, as a result, the drill fluid will increasingly become contaminated with bitumen. As a result of the emulsifier within the drilling fluid, the bitumen will be emulsified within the water primary phase of the drilling solution. Left unadjusted, the drilling solution will become progressively more viscous as a result of water loss to the formation through seepage and other factors. As a result, the drill operator will normally adjust the chemistry of the drilling fluid such that the viscosity of the fluid is maintained within acceptable parameters in order that drilling can continue. Under normal drilling, drill cuttings may be removed at the shaker.

In accordance with the invention and at an appropriate distance in advance of the planned drilling distance, the operator will adjust the properties of the drilling fluid such that a maximum quantity of heavy hydrocarbon is emulsified within the drill fluid together with suspended drill cuttings. In other words, the operator will allow the viscosity of the drilling fluid to rise such that a maximum amount of heavy hydrocarbon and drill cuttings are emulsified or suspended in the drilling fluid. Ideally, the drill operator will allow the viscosity of the drilling fluid to rise at an appropriate time prior to reaching the planned distance such that upon reaching the planned distance the drilling fluid viscosity has reached or is very close to the maximum viscosity to permit further drilling.

At the planned distance, drilling is stopped and the viscous drilling fluid containing the emulsified heavy hydrocarbons and suspended drill cuttings is pumped to the surface by displacing the viscous drilling fluid with a cleaning solution.

The viscous drilling fluid is collected at the surface and ideally will contain greater than 60% (w/w) heavy hydrocarbon. This viscous drilling fluid may then be used for other applications.

Road Construction

As is known, a typical road construction includes a sub-grade of supporting native rock, soil, sand, clay or other material onto which a base course generally comprising a depth of crushed gravel or aggregate is placed and compacted with a surface course of a smaller gradation. The aggregate will usually range in depth from 12 inches to several feet depending on the engineering requirements of the road and may include various additives that provide dust suppression if the road is not to be sealed.

In a sealed road, a surface course of a concrete (usually an asphalt concrete) is applied and compacted over the aggregate to seal and bind the upper surface of the road. The asphalt is a complex mixture of hydrocarbons primarily comprised of bitumen which in itself is generally comprised of asphaltenes as the dispersed phase and maltenes as the continuous phase. Mixed with various aggregates or mixtures of aggregates, varying blends of asphalt concrete can be produced depending on the desired qualities for the road surface.

In accordance with one embodiment of the invention, upon completion of the drilling, the recovered viscous heavy hydrocarbon/drill cuttings mixture is transported to an asphalt preparation facility where the mixture may be upgraded through the addition of further amounts of asphalt/bitumen and other materials that produce a product suitable for use as an asphalt emulsion. The resulting product may then be used in an appropriate road construction application as an asphalt cement or dust suppressant as described above.

Fuel

In an alternate embodiment, the recovered heavy hydrocarbon/drill cuttings are upgraded for use as a fuel. In this embodiment, the drill cuttings may be separated from the recovered drilling fluid/drill cuttings on surface to an acceptable level whereupon the hydrocarbon content may be increased to a level suitable for using the mixture as an emulsion fuel. In another embodiment, if the hydrocarbon content is sufficiently high, the drilling fluid/drill cuttings mixture may be used directly as a fuel without separation.

In this embodiment, the use of the heavy hydrocarbon/drill cuttings mixture as a fuel may be an effective way of decontaminating the drill cuttings such that the “burnt” drill cuttings have been cleansed of contaminants, thus enabling remediation of the drill cuttings to soil or use in another application.

Surfactants

Surfactants may include those surfactants used in the road asphalting industry including anionic, cationic and non-surfactants such as fatty acids and sodium or potassium-based soaps and others as known to those skilled in the art.

The above-described embodiments of the invention are intended to be examples only. Alterations, modifications and variations may be effected to the particular embodiments by those of skill in the art without departing from the scope of the invention which is defined by the following claims.

1. A method of preparing a viscous heavy hydrocarbon/drilling solution emulsion comprising the step of preparing a water-based drilling solution containing an effective amount of a surfactant wherein the drilling solution is effective in emulsifying heavy hydrocarbon from a production zone and forming a viscous heavy hydrocarbon/drilling solution emulsion with suspended drill cuttings during drilling.

2. A method as in claim 1 wherein the heavy hydrocarbon is bitumen.

3. A method as in claim 1 wherein the heavy hydrocarbon concentration within the viscous heavy hydrocarbon/drilling solution emulsion with suspended drill cuttings is 60% (w/w) or higher.

4. A method as in claim 2 further comprising the step of recovering the bitumen/drilling solution emulsion at surface and transporting the emulsion to an asphalt preparation facility or directly to an end use site.

5. A method as in claim 4 further comprising the step of increasing the hydrocarbon fraction within the bitumen/drilling solution emulsion to create an asphalt emulsion suitable for road construction.

6. A method as in claim 4 further comprising the step of using the asphalt emulsion as asphalt cement or a dust suppressant in a road.

7. A method as in claim 1 further comprising the step of recovering the heavy hydrocarbon/drilling solution emulsion at surface and separating drill cuttings from the emulsion.

8. A method as in claim 7 further comprising increasing the hydrocarbon fraction within the heavy hydrocarbon/drilling solution emulsion to create a water-emulsion fuel.

9. A water-based drilling fluid produced from downhole drilling comprising:
a water phase;
at least one surfactant for dispersing/emulsifying downhole heavy hydrocarbons;
emulsified heavy hydrocarbon and,
drill cuttings from the downhole drilling
wherein the water-based drilling fluid is characterized by having at least 60% (w/w) dispersed heavy hydrocarbon with respect to the water phase and associated drill cuttings.

10. A drilling fluid as in claim 9 wherein the one or more surfactants is selected from any one of or a combination of an anionic, cationic or non-ionic surfactant.

11. A method of preparing the drilling fluid of claim 9 comprising the steps of:
a. forming a water-based drilling fluid with an emulsifier;
b. drilling a wellbore with the water-based drilling fluid wherein upon approaching a planned drilling distance through a production zone having heavy hydrocarbons, the viscosity of the drilling fluid is permitted to increase by increasing the concentration of emulsified heavy hydrocarbon within the drilling fluid; and,
c. recovering the viscous drilling fluid at the surface.

12. A method as in claim 11 wherein the concentration of heavy hydrocarbon within the viscous drilling fluid is 60% (w/w) or greater.
